(19) United States
(12) Patent Application Publication
(10) Pub. No.: US 2020/0052262 A1
(43) Pub. Date: Feb. 13, 2020

(54) Portable Battery Case Capable of Suppressing Fires

(71) Applicant: Brian King, Chicago, IL (US)

(72) Inventor: Brian King, Chicago, IL (US)

(21) Appl. No.: 16/539,061

(22) Filed: Aug. 13, 2019

Related U.S. Application Data
(60) Provisional application No. 62/718,113, filed on Aug. 13, 2018.

(51) Int. Cl. H01M 2/10; B65D 81/38

(52) U.S. Cl. CPC H01M 2/1094; B65D 81/3823

(57) ABSTRACT

The portable battery case capable of suppressing fires includes a fire resistant case, a fire resistant lid, a lid fastener, at least one port, a temperature gage. The fire resistant case includes an outer layer, an intermediate layer that is made of fire resistant material, an inner layer, and a chamber. The chamber is delineated within the inner layer to secures the battery. The outer layer is hermetically connected to the inner layer so that the intermediate layer can be interposed between the inner layer and the outer layer. The fire resistant lid is terminally connected to the outer layer. The chamber is enclosed by the fire resistant lid and the lid fastener. The port is laterally integrated onto the fire resistant case in order to insert a power case. The temperature gage is laterally integrated onto the fire resistant case.

The current application claims a priority to the U.S. Provisional Patent application Ser. No. 62/718,113 filed on Aug. 13, 2018.

### FIELD OF THE INVENTION

The present invention relates generally to battery carriers and the like. More specifically, the present invention is a battery carrier capable of suppressing fires and other relatable incidences that can occur from batteries.

### BACKGROUND OF THE INVENTION

In present society, many people bring their own electronic devices onto airplanes. These electronic devices can range from laptops to handheld gaming devices to smart devices. However, in recent years, many airline carriers have prohibited certain electronic devices from being carried on to an airplane cabin because of the potential for the batteries of these electronic devices to become instantaneously combustible, erupt into flames, and/or produce hazardous smokes. To prevent such incidences from occurring in airplane cabins, many airline carriers have mandated that the batteries from these electronic devices be turned off during takeoff, landing, and/or while in flight, or be removed prior to boarding the flight. Some airline carriers will even go as far as prohibiting these devices completely from being carried on to airplane cabins or even in stored in airplane's cargo bay. There do exist fire-proof cases or carriers in which a user can store their batteries within. However, many of these devices do not possess the capability for users to utilize the batteries while the batteries are connected to their device or while the batteries are being charged.

An objective of the present invention is to provide users with a battery carrier capable of suppressing fires and other relatable incidences that can occur from batteries. The present invention intends to provide users with a battery carrier that can universally contain any kind or type, shape, size, and/or quantity of batteries. The present invention intends to provide users with a battery carrier that contains multiple suppression of the battery fire, side-effects of the battery fire, after-effects of the battery fire, and other similarly relatable incidences. The present invention intends to provide users with a battery carrier with the capability for users to utilize the batteries while the batteries are stored within the present invention. The present invention intends to provide users with additional features that make the present invention suitable for storage and transportation.

### SUMMARY OF THE INVENTION

The present invention is a battery carrier capable of suppressing fires and other relatable incidences that can occur from batteries. The present invention contains a case with an attached lid. The lid contains a handle and a means of closure to either close the lid against the case or open the lid to expose the inside of the case. The case contains three layers: an outer layer, an inner layer, and an intermediary layer. The outer layer is of a fire-proof material, or similar, and contains a single port. The inner layer is of a fire-proof material, or similar, and contains a plurality of a drain holes. The intermediary layer is gap between the outer layer and the inner layer. The intermediary layer also contains a plurality of beads made of a fire-suppression material or similar.

### BRIEF DESCRIPTION OF THE DRAWINGS

FIG. 1 is a front perspective view of the present invention, wherein the fire resistant lid is covering the chamber.

FIG. 2 is a rear perspective view of the present invention, wherein the fire resistant lid is covering the chamber and showing the case fastener.

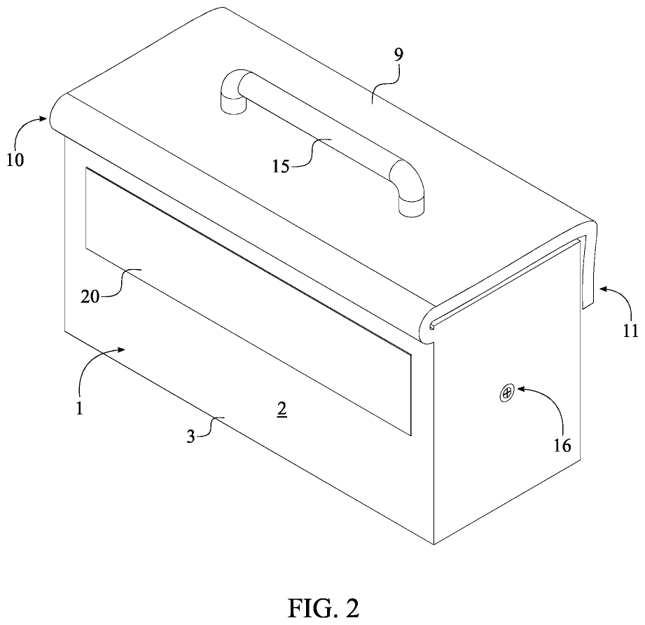

FIG. 3 is a front perspective view of the present invention, wherein the chamber opened.

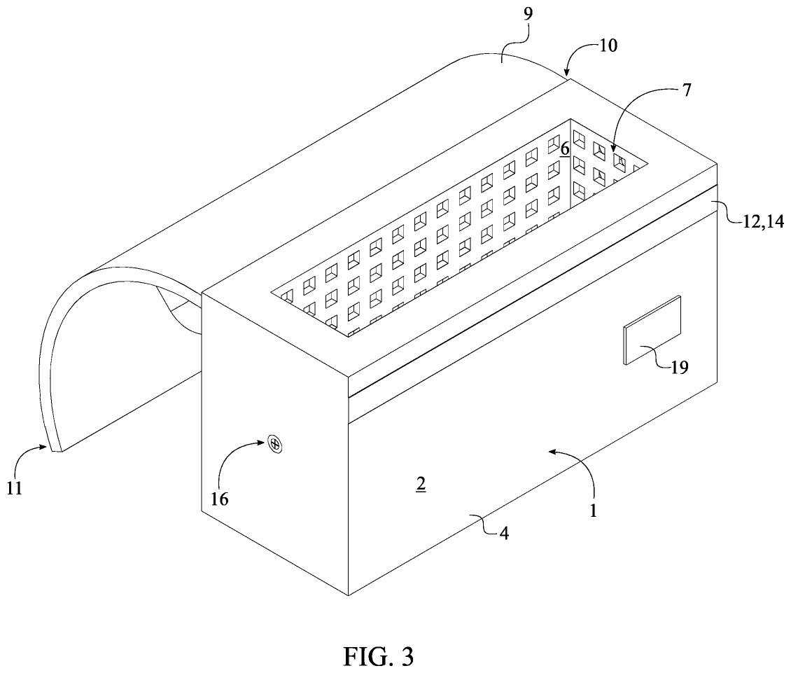

FIG. 4 is a rear perspective view of the present invention, wherein the chamber opened.

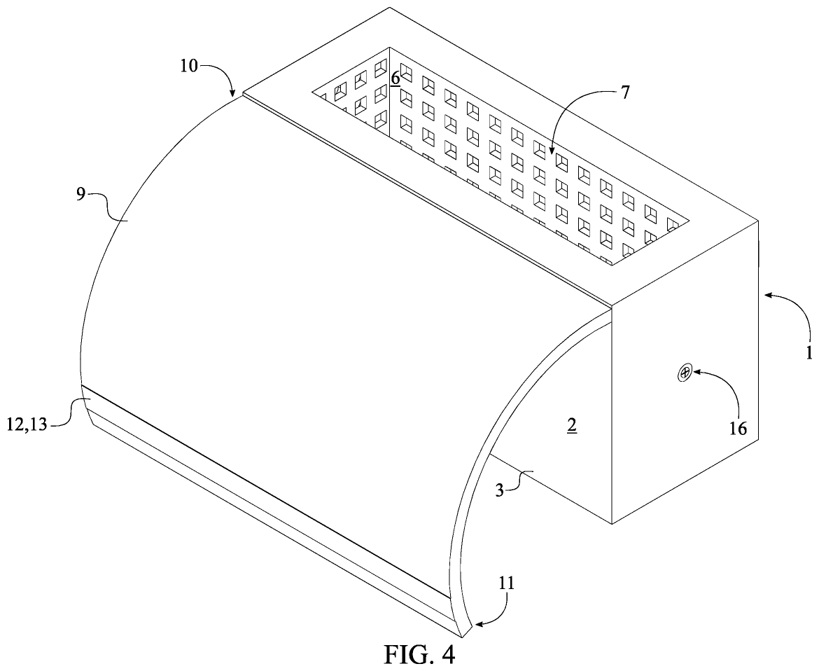

FIG. 5 is a front perspective view of the present invention, wherein the fire resistant case cut though to illustrate the three different layers of the fire resistant case.

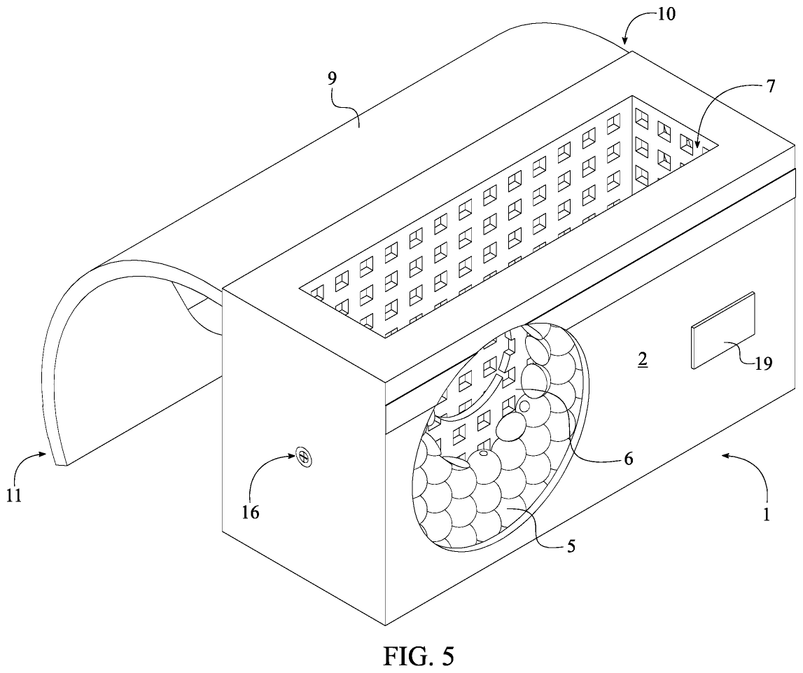

FIG. 6 is a cross-sectional view of the present invention showing the three different layers of the fire resistant case

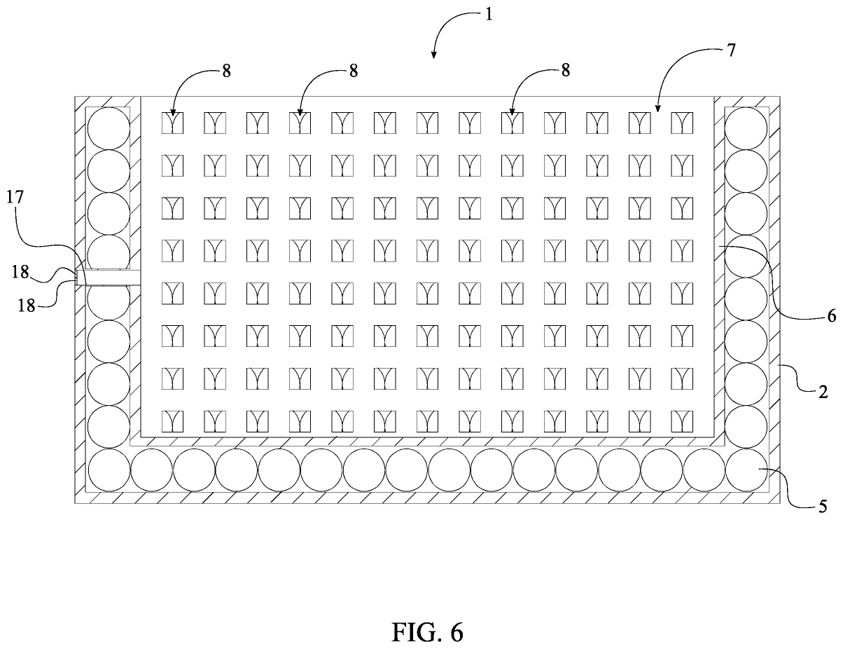

FIG. 7 is a detailed view cross-sectional view of the port of the present invention.

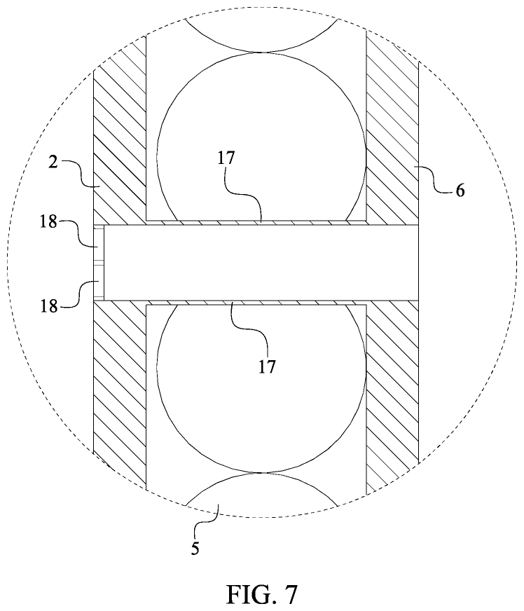

### DETAIL DESCRIPTIONS OF THE INVENTION

All illustrations of the drawings are for the purpose of describing selected versions of the present invention and are not intended to limit the scope of the present invention.

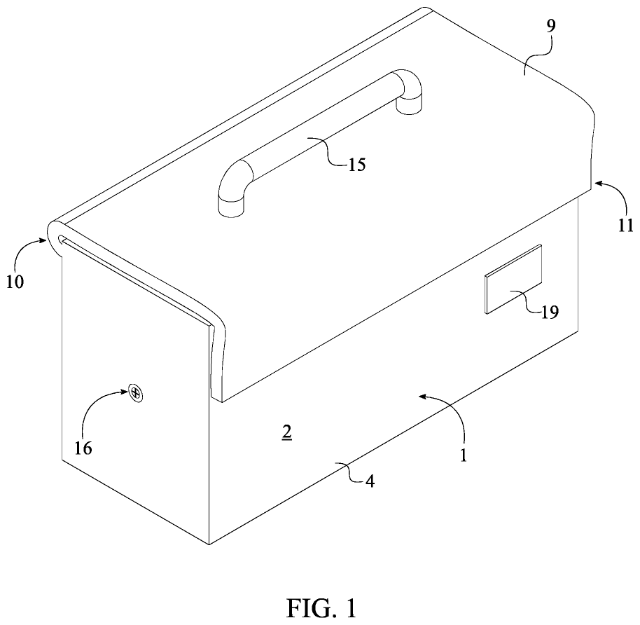

The present invention is a portable battery case capable of suppressing fires and other relatable incidences that can occur from batteries. The present invention can be of any shape, size, material, features, type or kind, orientation, location, quantity, components, and arrangements of components that would allow the present invention to fulfill the objectives and intents of the present invention. However, it is preferred that the present invention be of a material or a combination of materials that is strong, tough, flexible, heat-resistant, fire-suppressant, fire-retardant, fire-proof, insulating, lightweight, leak-proof, tear-resistant, non-flammable, non-toxic, and/or durable. The present invention comprises a fire resistant case 1, a fire resistant lid 9, a lid fastener 12, at least one port 16, and a temperature gage 19 as shown in FIG. 1.

The fire resistant case 1 functions as the main structural body so that the battery can be placed within. The fire resistant case 1 comprises an outer layer 2, an intermediate layer 5, an inner layer 6, and a chamber 7. It is preferred that the fire resistant case 1 be of a shape similar to the shape of the battery being contained within and slightly larger than size of the battery so that the battery can be easily placed within. In reference to FIG. 1, the fire resistant case 1 comprises an outer layer 2, an intermediate layer 5, an inner layer 6, and a chamber 7. The chamber 7 is delineated within the inner layer 6 thus providing an empty space to place the battery within. The present invention further comprises a plurality of openings 8 so that the heat energy generated by the battery can be dissipated away from the chamber 7. In order to accomplish the dissipation of heat energy, the plurality of openings 8 traverses through the inner layer 6. In order words, depth of each of the plurality of holes is similar to the thickness of the inner layer 6. The outer layer 2 that comprises a first lateral side 3 and a second lateral side 4 is hermetically connected to the inner layer 6. The outer layer 2 delineate a similar shape and structure as the inner layer 6 so that the inner layer 6 can be positioned within the outer layer 2. The first lateral side 3 and the second lateral side 4 are oppositely positioned of each other about the fire resistant case 1, preferably along the length of the fire resistant case 1. The intermediate layer 5 is interposed between the inner layer 6 and the outer layer 2. Furthermore, the intermediate layer 5 is fire resistant material so that the present invention can suppresses any fires that can initial within the chamber 7. It is preferred that the intermediate layer 5 be of a material and type or kind similar to water beads, gel beads, water crystal gel, or any other natural or chemical materials that can suppress fire.

The fire resistant lid 9 covers the opening of the chamber 7 so that the present invention can be fully fire resistant. In reference to FIG. 1, the fire resistant lid 9 is terminally connected to the outer layer 2 from one end as the chamber 7 is enclosed by the fire resistant lid 9 and the lid fastener 12. More specifically, a fixed end 10 of the fire resistant lid 9 is terminally connected to the first lateral side 3. Resultantly, a free end 11 of the fire resistant lid 9 can be terminally mounted to the second lateral side 4 by the lid fastener 12. In reference to FIG. 1, the lid fastener 12 comprises a first fastening section 13 and a second fastening section 14. The first fastening section 13 is laterally connected to the free end 11 of the fire resistant lid 9. The second fastening section 14 is laterally connected to the second lateral side 4. For example, when the fire resistant lid 9 fully encloses the chamber 7, the first fastening section 13 and the second fastening section 14 are attached to each other. When the fire resistant lid 9 does not enclose the chamber 7, the first fastening section 13 and the second fastening section 14 are detached from each other. The lid fastener 12 can be any types of easily detachable fasteners including, but is not limited to, hook and loop fasteners, male and female fasteners, and magnetic fasteners.

The present invention further comprises a handle 15 as shown in FIG. 1. More specifically, the handle 15 is laterally connected onto the fire resistant lid 9 and oriented away from the fire resistant case 1. The handle 15 provides sufficient surface area within the present invention so that the present invention can be carried by the user.

The port 16 is laterally integrated onto the fire resistant case 1 so that the user is able to insert a power cable of battery through the fire resistant case 1. In other words, the power cable of the battery that recharges a device or recharges the battery itself is able to insert through the port 16 without compromising functionality of the fire resistant case 1 and the fire resistant lid 9. In reference to FIG. 1, the port 16 comprises a channel wall 17 and a plurality of flaps 18. More specifically, the channel wall 17 traverses through the outer layer 2, the intermediate layer 5, and the inner layer 6 in such a way that the port 16 is extended from outer layer 2 to the chamber 7. The plurality of flaps 18 is radially connected within the channel wall 17. The plurality of flaps 18 functions as flexible wings so that different diameter power cables can be inserted and secured within the port 16. The plurality of flaps 18 is positioned adjacent to the outer layer 2 so that dust and other unnecessary elements can be blocked.

In reference to FIG. 1, the temperature gage 19 that indicates the temperature of the fire resistant case 1 is laterally integrated onto the fire resistant case 1. More specifically, the temperature gage 19 is laterally connected onto the outer layer 2 so that the user is able to easily view the corresponding temperature of the fire resistant case 1. The temperature gage 19 can be a digital thermometer, an analog thermometer, a liquid crystal thermometer, or any other types of thermometers.

The present invention further comprises a case fastener 20 so that the fire resistant case 1 can be secured to a luggage or any other surface. In reference to FIG. 1, the case fastener 20 is laterally connected onto the outer layer 2 and preferably positioned opposite of the lid fastener 12 so that the fire resistant lid 9 can be opened and closed independent from the case fastener 20. The case fastener 20 is preferably a hook and loop fastener but can be any other type of fasteners such as a magnetic fastener, an adhesive fastener, and a suction fastener.

Although the invention has been explained in relation to its preferred embodiment, it is to be understood that many other possible modifications and variations can be made without departing from the spirit and scope of the invention as hereinafter claimed.

What is claimed is:

1. A portable battery case capable of suppressing fires comprising;
a fire resistant case;
a fire resistant lid;
a lid fastener;
at least one port;
a temperature gage;
the fire resistant case comprising an outer layer, an intermediate layer, an inner layer, and a chamber;
the chamber being delineated within the inner layer;
the outer layer being hermetically connected to the inner layer;
the intermediate layer being interposed between the inner layer and the outer layer;
the fire resistant lid being terminally connected to the outer layer;
the chamber being enclosed by the fire resistant lid and the lid fastener;
the port being laterally integrated onto the fire resistant case; and
the temperature gage being laterally integrated onto the fire resistant case.

2. The portable battery case capable of suppressing fires as claimed in claim 1, wherein the intermediate layer is fire resistant material.

3. The portable battery case capable of suppressing fires as claimed in claim 1 comprising:
a plurality of openings; and
the plurality of openings traversing through the inner layer.

4. The portable battery case capable of suppressing fires as claimed in claim 1 comprising:
the outer layer comprising a first lateral side and a second lateral side;
the first lateral side and the second lateral side being oppositely positioned of each other about the fire resistant case;
a fixed end of the fire resistant lid being terminally connected to the first lateral side; and
a free end of the fire resistant lid being terminally mounted to the second lateral side by the lid fastener.

5. The portable battery case capable of suppressing fires as claimed in claim 4 comprising:
the lid fastener comprising a first fastening section and a second fastening section;
the first fastening section being laterally connected to the free end of the fire resistant lid;
the second fastening section being laterally connected to the second lateral side; and
the first fastening section and the second fastening section being attached to each other.

6. The portable battery case capable of suppressing fires as claimed in claim 1 comprising:
a handle; and
the handle being laterally connected onto the fire resistant lid.

7. The portable battery case capable of suppressing fires as claimed in claim 1 comprising:
the port comprising a channel wall and a plurality of flaps;
the channel wall traversing through the outer layer, the intermediate layer, and the inner layer;
the plurality of flaps being radially connected within the channel wall; and
the plurality of flaps being positioned adjacent to the outer layer.

8. The portable battery case capable of suppressing fires as claimed in claim 1 comprising:
a case fastener; and
the case fastener being laterally connected onto the outer layer.

9. The portable battery case capable of suppressing fires as claimed in claim 1, wherein the temperature gage is laterally connected onto the outer layer.
